(19) United States
(12) Patent Application Publication
(10) Pub. No.: US 2013/0156261 A1
(43) Pub. Date: Jun. 20, 2013

(54) METHOD AND APPARATUS FOR OBJECT DETECTION USING COMPRESSIVE SENSING

(71) Applicants: Hong Jiang, Warren, NJ (US); Paul Wilford, Bernardsville, NJ (US)

(72) Inventors: Hong Jiang, Warren, NJ (US); Paul Wilford, Bernardsville, NJ (US)

(73) Assignee: ALCATEL-LUCENT USA INC., Murray Hill, NJ (US)

(21) Appl. No.: 13/328,149

(22) Filed: Dec. 16, 2011

(51) Int. Cl. G06K 9/00

(52) U.S. Cl. 382/103

(57) ABSTRACT

In one embodiment, the method for object detection and compressive sensing includes receiving, by a decoder, measurements. The measurements are coded data that represents video data. The method further includes estimating, by the decoder, probability density functions based upon the measurements. The method further includes identifying, by the decoder, a background image and at least one foreground image based upon the estimated probability density functions. The method further includes examining the at least one foreground image to detect at least one object of interest.

### BACKGROUND

Conventional surveillance systems involve a relatively large amount of video data stemming from the amount of time spent monitoring a particular place or location and the number of cameras used in the surveillance system. However, among the vast amounts of captured video data, the detection of anomalies/foreign objects is of prime interest. As such, there may be a relatively large amount of video data that will be unused.

In most conventional surveillance systems, the video from a camera is not encoded. As a result, these conventional systems have a large bandwidth requirement, as well as high power consumption for wireless cameras. In other types of conventional surveillance systems, the video from a camera is encoded using Motion JPEG, MPEG/H.264. However, this type of encoding involves high complexity and/or high power consumption for wireless cameras.

Further, conventional surveillance systems rely upon background subtraction methods to detect an object of interest and to follow its movement. If a conventional decoder receives encoded data from the cameras in the system, the decoder must first reconstruct each pixel before the conventional decoder is able to perform the background subtraction methods. However, such reconstruction adds considerably to the time and processing power required of the conventional decoder.

### SUMMARY

Embodiments relate to a method and/or apparatus for object detection and compressive sensing in a communication system.

In one embodiment, the method for object detection and compressive sensing includes receiving, by a decoder, measurements. The measurements are coded data that represents video data. The method further includes estimating, by the decoder, probability density functions based upon the measurements. The method further includes identifying, by the decoder, a background image and at least one foreground image based upon the estimated probability density functions. The method further includes examining the at least one foreground image to detect at least one object of interest.

The method may further include obtaining, by the decoder, a range of pixel values of video data that satisfy an expression characterizing a relationship based upon the measurements, determining intermediate functions based upon the range of pixel values, and performing a convolution of the intermediate functions to obtain the estimated probability density functions.

The method may further include obtaining, by the decoder, estimated pixel values of the video data that satisfy a minimization problem, and determining, by the decoder, histograms based upon the estimated pixel values. The histograms represent the estimated probability density functions.

In one embodiment, the estimating step models the estimated probability density functions as a mixture Gaussian distribution.

In one embodiment, the identifying step identifies the background image using a mathematical mode of the estimated probability density functions.

The method may include obtaining, by the decoder, estimated pixel values of the video data that satisfy a minimization problem. The method further includes obtaining, by the decoder, at least one foreground image by subtracting the background image from the estimated pixel values of the video data. The method further includes examining the at least one foreground image to detect at least one object of interest.

Also, the method may include obtaining, by the decoder, a range of pixel values of video data that satisfy an expression characterizing a relationship based upon the measurements. The method further includes determining, by the decoder, a shape property and a motion property of the at least one foreground object. The method further includes examining the shape property and the motion property of the at least one foreground object to detect at least one object of interest.

In one embodiment, the video data is luminance data.

In one embodiment, the video data is chrominance data.

In one embodiment, an apparatus for detecting at least one object of interest within data in a communication system includes a decoder configured to receive measurements. The measurements are coded data representing the video data. The decoder is configured to estimate probability density functions for the video data based upon the measurements. The decoder is configured to identify a background image and at least one foreground image based upon the estimated probability density functions. The decoder is configured to examine the at least one foreground image to detect at least one object of interest.

In one embodiment, the decoder is further configured to obtain a range of pixel values of video data that satisfy an expression characterizing a relationship based upon the measurements. The decoder is configured to determine a shape property and a motion property of the at least one foreground object. The decoder is also configured to examine the shape property and the motion property of the at least one foreground object to detect at least one object of interest.

The decoder may further be configured to obtain a range of pixel values of video data that satisfy an expression characterizing a relationship based upon the measurements. The decoder may further be configured to determine intermediate functions based upon the range of pixel values. The decoder may further be configured to perform a convolution of the intermediate functions to obtain the estimated probability density functions.

The decoder may further be configured to obtain estimated pixel values of the video data that satisfy a minimization problem. The decoder may further be configured to determine histograms based upon the estimated pixel values. The histograms represent the estimated probability density functions.

In one embodiment, the decoder models the estimated probability density functions as a mixture Gaussian distribution.

In another embodiment, the decoder identifies the background image using a mathematical mode of the estimated probability density functions.

The decoder may further be configured to obtain estimated pixel values of the video that satisfy a minimization problem. The decoder may further be configured to obtain at least one foreground image by subtracting the background image from the estimated pixel values of the video data. The decoder may further be configured to examine the at least one foreground image to detect at least one object of interest.

The decoder may further be configured to obtain a range of pixel values of video data that satisfy an expression characterizing a relationship based upon the measurements. The decoder may be configured to determine a shape property and a motion property of the at least one foreground object and to examine the shape property and the motion property of the at least one foreground object to detect at least one object of interest.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a communication network according to an embodiment;

FIG. 2 illustrates components of a camera assembly and a processing unit according to an embodiment;

FIG. 3 illustrates a method of detecting objects of interest in video data according to an embodiment;

FIG. 4 illustrates a method of estimating a probability density function according to an embodiment;

FIG. 5 illustrates a method of estimating a probability density function according to another embodiment;

FIG. 6 illustrates a method of estimating a probability density function according to still another embodiment;

FIG. 7 illustrates an example probability density function for one pixel of video data; and

FIG. 8 illustrates a method of detecting an object by calculating the shape and motion of the object.

### DETAILED DESCRIPTION OF EXAMPLE EMBODIMENTS

Various embodiments of the present disclosure will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,’ or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

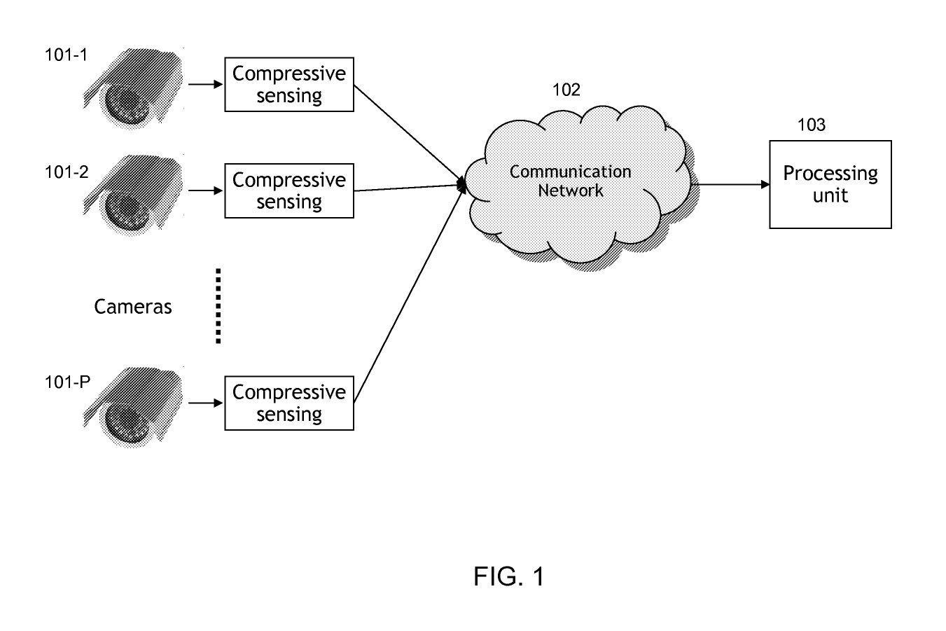

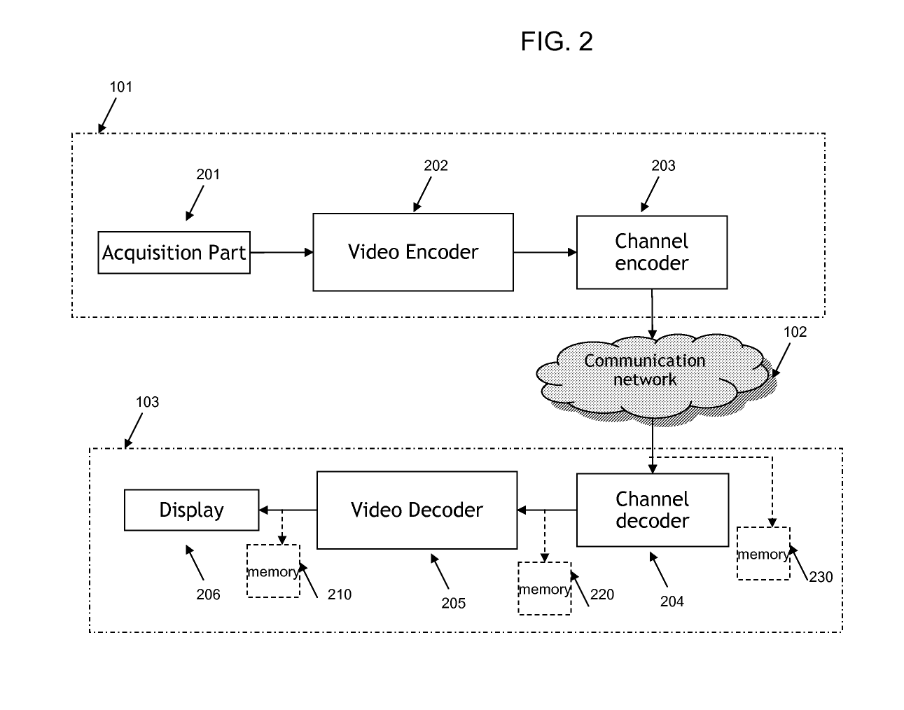

The embodiments include a method and apparatus for detecting objects of interest within data in a communication network. The overall network is further explained below with reference to FIG. 1. In one embodiment, the communication network may be a surveillance network. The communication network may include a camera assembly that encodes video data using compressive sensing, and transmits measurements that represent the acquired video data. The camera assembly may be stationary or movable, and the camera assembly may be operated continuously or in brief intervals which may be pre-scheduled or initiated on demand. Further, the communication network may include a processing unit that decodes the measurements and detects motion of at least one object within the acquired video data. The details of the camera assembly and the processing unit are further explained with reference to FIG. 2.

The video data includes a sequence of frames, where each frame may be represented by a pixel vector having N pixel values. N is the number of pixels in a video volume, where a video volume consists of a number of frames of the video. X(i,j,t) represents the value of a pixel at spatial location (i,j) and frame t. A camera assembly computes a set of M measurements Y (e.g., Y is a vector containing M values) on a per-volume basis for each frame by applying a measurement matrix to a frame of the video data, where M is less than N. The measurement matrix is a type of matrix having dimension M×N. In other words, the camera assembly generates measurements by applying the measurement matrix to the pixel vectors of the video data.

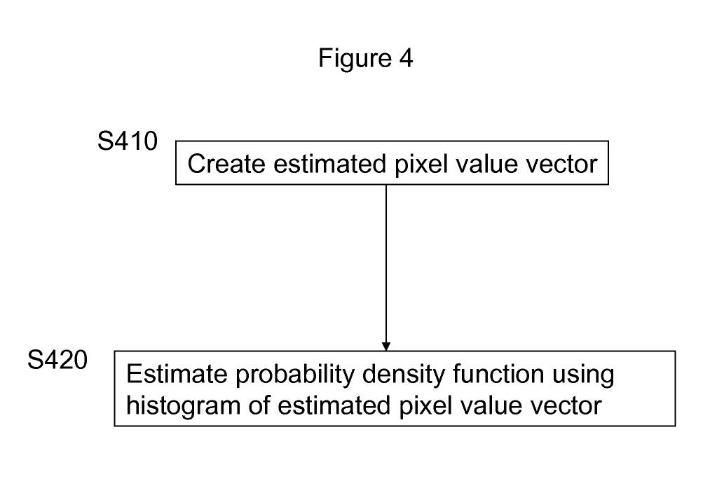

After receiving the measurements the processing unit may calculate estimated probability density functions based upon the measurements. The processing unit determines one estimated probability density function for each pixel of video data. The processing unit may determine estimated probability density functions based on methods described in FIGS. 4-6.

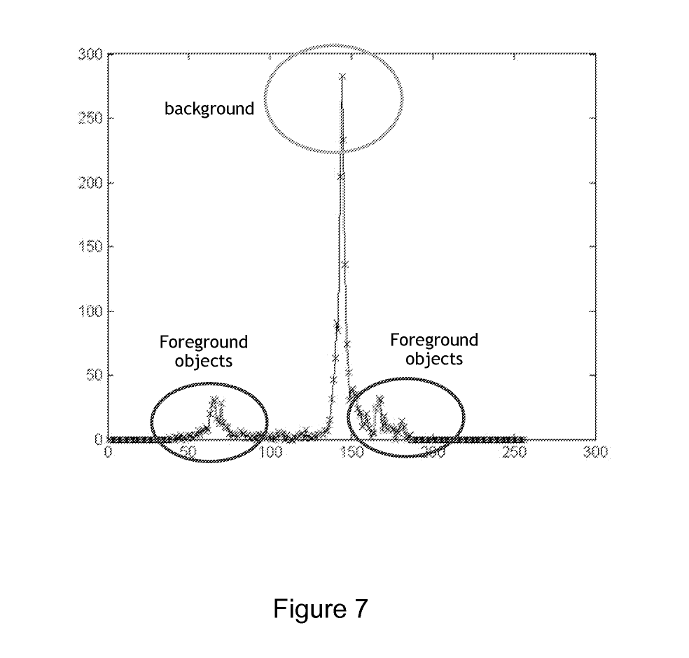

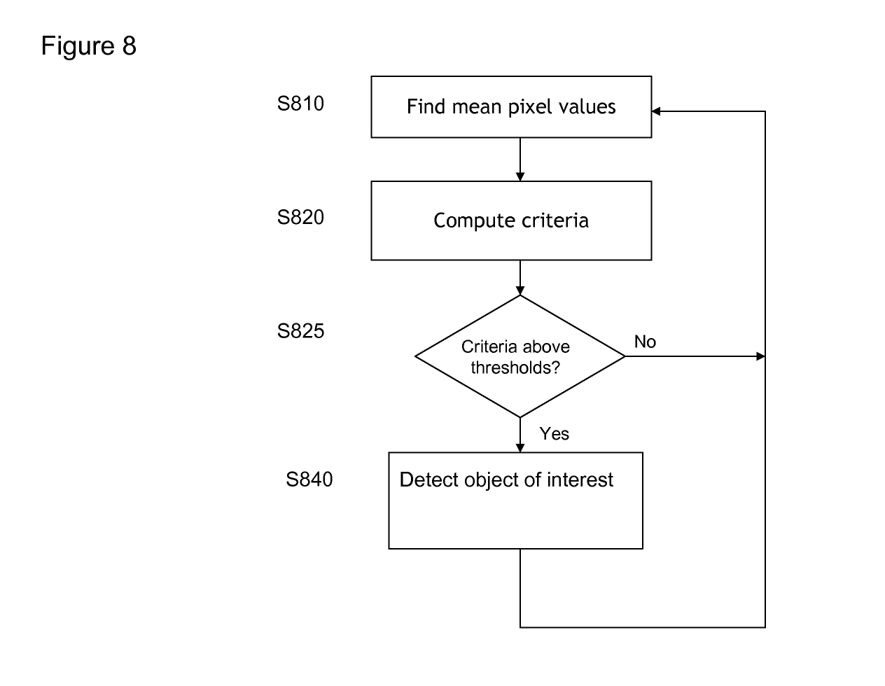

After calculating the estimated probability density functions, the processing unit may identify the background and foreground of the video. The processing unit may identify a background image based upon estimated probability density functions such as the estimated probability density function of FIG. 7. In an embodiment, after calculating the background image, the processing unit may identify at least one foreground image using a background subtraction. In another embodiment, the processing unit may calculate only the shape and motion of at least one foreground image to detect at least one object of interest. The processing unit may detect at least one object of interest by calculating shape and motion properties of an object and comparing the values of these properties to a threshold based on methods described in FIG. 8.

FIG. 1 illustrates a communication network according to an embodiment. In one embodiment, the communication network may be a surveillance network. The communication network includes one or more camera assemblies 101 for acquiring, encoding and/or transmitting data such as video, audio and/or image data, a communication network 102, and at least one processing unit 103 for receiving, decoding and/or displaying the received data. The camera assemblies 101 may include one camera assembly or a first camera assembly 101-1 to P^{th} camera assembly 101-P, where P is any integer greater or equal to two. The communication network 102 may be any known transmission, wireless or wired, network. For example, the communication network 102 may be a wireless network which includes a radio network controller (RNC), a base station (BS), or any other known component necessary for the transmission of data over the communication network 102 from one device to another device.

The camera assembly 101 may be any type of device capable of acquiring data and encoding the data for transmission via the communication network 102. Each camera assembly device 101 includes a camera for acquiring video data, at least one processor, a memory, and an application storing instructions to be carried out by the processor. The acquisition, encoding, transmitting or any other function of the camera assembly 101 may be controlled by the at least one processor. However, a number of separate processors may be provided to control a specific type of function or a number of functions of the camera assembly 101.

The processing unit 103 may be any type of device capable of receiving, decoding and/or displaying data such as a personal computer system, mobile video phone, smart phones or any type of computing device that may receive data from the communication network 102. The receiving, decoding, and displaying or any other function of the processing unit 103 may be controlled by at least one processor. However, a number of separate processors may be provided to control a specific type of function or a number of functions of the processing unit 103.

FIG. 2 illustrates functional components of the camera assembly 101 and the processing unit 103 according to an embodiment. For example, the camera assembly 101 includes an acquisition part 201, a video encoder 202, and a channel encoder 203. In addition, the camera assembly 101 may include other components that are well known to one of ordinary skill in the art. Referring to FIG. 2, in the case of video, the acquisition part 201 may acquire data from the video camera component included in the camera assembly 101 or connected to the camera assembly 101. The acquisition of data (video, audio and/or image) may be accomplished according to any well known methods. Although the below descriptions describes the encoding and decoding of video data, similar methods may be used for image data or audio data, or any other type of data that may be represented by a set of values.

The video encoder 202 encodes the acquired data using compressive sensing to generate measurements to be stored on a computer-readable medium such as an optical disk or internal storage unit or to be transmitted to the processing unit 103 via the communication network 102. It is also possible to combine the functionality of the acquisition part 201 and the video encoder 202 into one unit. Also, it is noted that the acquisition part 201, the video encoder 202 and the channel encoder 203 may be implemented in one, two or any number of units.

The channel encoder 203 codes or packetizes the measurements to be transmitted over the communication network 102. For example, the measurements may be processed to include parity bits for error protection, as is well known in the art, before they are transmitted or stored. Then, the channel encoder 203 may then transmit the coded measurements to the processing unit 103 or store them in a storage unit.

The processing unit 103 includes a channel decoder 204, a video decoder 205, and optionally a video display 206. The processing unit 103 may include other components that are well known to one of ordinary skill in the art. The channel decoder 204 decodes the measurements received from the communication network 102. For example, measurements are processed to detect and/or correct errors from the transmission by using the parity bits of the data. The correctly received packets are unpacketized to produce the quantized measurements generated in the video encoder 202. It is well known in the art that data can be packetized and coded in such a way that a received packet at the channel decoder 204 can be decoded, and after decoding the packet can be either corrected, free of transmission error, or the packet can be found to contain transmission errors that cannot be corrected, in which case the packet is considered to be lost. In other words, the channel decoder 204 is able to process a received packet to attempt to correct errors in the packet, to determine whether or not the processed packet has errors, and to forward only the correct measurements information from an error free packet to the video decoder 205. Measurements received from the communication network 102 may further be stored in a memory 230. The memory 230 may be a computer readable medium such as an optical disc or storage unit.

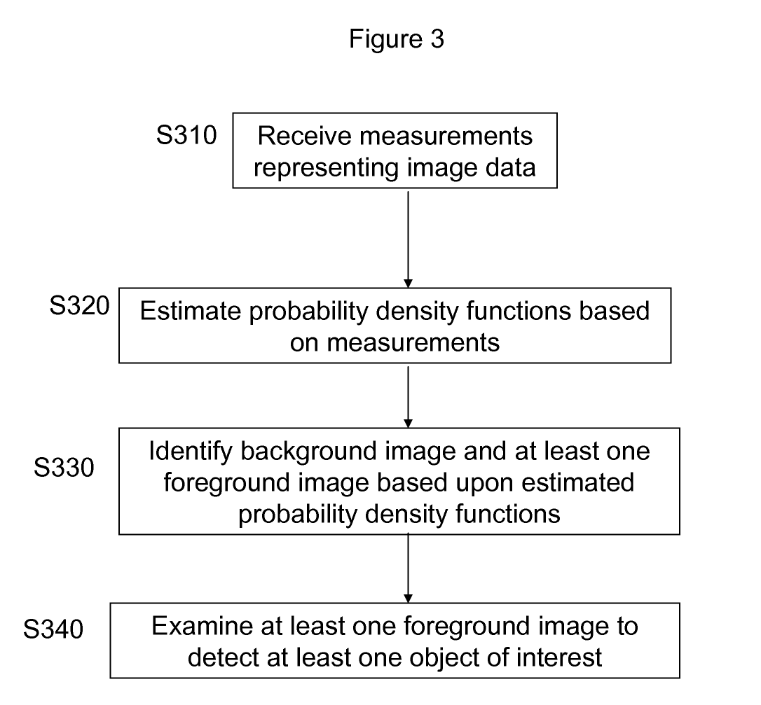

The video decoder 205 receives the correctly received measurements and identifies objects of interest in the video data. The video decoder 205 may receive transmitted measurements or receive measurements that have been stored on a computer readable medium such as an optical disc or storage unit 220. The details of the video decoder 205 are further explained with reference to FIGS. 3-6.

The display 206 may be a video display screen of a particular size, for example. The display 206 may be included in the processing unit 103, or may be connected (wirelessly, wired) to the processing unit 103. The processing unit 103 displays the decoded video data on the display 206 of the processing unit 103. Also, it is noted that the display 206, the video decoder 205 and the channel decoder 204 may be implemented in one or any number of units. Furthermore, instead of the display 206, the processed data may be sent to another processing unit for further analysis, such as, determining whether the objects are persons, cars, etc. The processed data may also be stored in a memory 210. The memory 210 may be a computer-readable medium such as an optical disc or storage unit.

FIG. 3 illustrates a method of detecting objects of interest in the communication system according to an embodiment.

In step S310, the video decoder 205 receives measurements Y that represent the video data. As previously described, the measurements Y may be considered a vector having M measurements. The video x consists of a number of frames, each of which has a number of pixels.

In step S320, the video decoder 205 estimates probability density functions. The video x consists of a number of frames, each of which has a number of pixels. X(i,j,t) is the pixel value of the video at spatial location (i,j) of frame t. The video decoder 205 estimates a probability density function (pdf) ƒ_{X(i,j)}(x) for each pixel (i,j). Stated differently, for each given pixel (i,j), the values X(i,j,t), t=0, 1, 2, . . . , are samples from a random process whose probability density function is ƒ_{X(i,j)}(x). The video decoder 205 estimates the probability density function ƒ_{X(i,j)}(x) using only the compressive measurements Y=φX, without the knowledge of X(i,j,t).

FIG. 4 illustrates a method of estimating probability density functions according to an embodiment.

In step S410, the video decoder 205 reconstructs an estimate of X(i,j,t), \hat{X}(i,j,t) using the measurements Y and the measurement matrix φ based on the following minimization problem:

min∥ψ(X)∥₁, subject to Y=φX (1)

where the function ψ represents a regularization function, such as:

$$ψ ( X ) = TV ( X ) = {\sum }_{i , j} \vert X ( i , j + 1 , t ) - X ( i , j , t ) \vert + \vert X ( i + 1 , j , t ) - X ( i , j , t ) \vert$$

where X is a vector of length N formed from a video volume, and N is the number of pixels in the video volume.

In step S420, the video decoder 205 estimates the probability density function \hat{ƒ}_{X(i,j)}(x) by using a histogram. A histogram at a pixel is an estimate of the probability density function of that pixel, which is computed by counting the number of times a value occurs at the pixel in the number of frames of the video volume. The parameter x refers to the particular frame. Assume the pixel value of the video is represented by an eight-bit number, from 0 to 255. Then the probability density function \hat{ƒ}_{X(i,j)}(x) can be a table with 256 entries, defined by the following pseudo-code

for t=0,1,2,...,T
\hat{f}_{X(i,j)}([\hat{X}(i,j,t)]) = \hat{f}_{X(i,j)}([\hat{X}(i,j,t)]) + 1
end for

where [•] denotes the nearest integer of the argument.

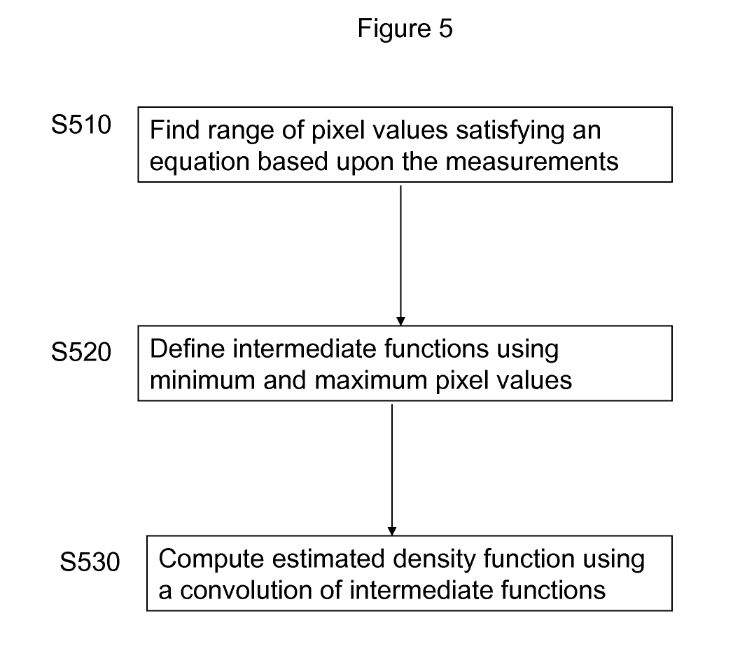

FIG. 5 illustrates a method of estimating probability density functions according to another embodiment.

In step S510, for each given spatial coordinate and temporal value (i,j,t), the video decoder 205 determines a range of values of X(i,j,t), [Xₘᵢₙ(i,j,t), Xₘₐₓ(i,j,t)], which satisfies the equation Y=φX. The video decoder 205 can determine this range using a well-known linear programming problem.

In step S520, the video decoder 205 defines intermediate functions based upon Xₘᵢₙ and Xₘₐₓ. The intermediate functions are defined according to the equation below:

$${U}_{i , j , t} ( x ) = \{ \begin{matrix}δ ( x - {X}_{min} ( i , j , t ) ) , & if {X}_{min} ( i , j , t ) = {X}_{max} ( i , j , t ) \\ \frac{1}{{X}_{max} ( i , j , t ) - {X}_{min} ( i , j , t )} , & if x ∈ [ {X}_{min} ( i , j , t ) , {X}_{max} ( i , j , t ) ] \\ 0 , & if x ∉ [ {X}_{min} ( i , j , t ) , {X}_{max} ( i , j , t ) ]\end{matrix} \qquad ( 2 )$$

where δ(•) is the Dirac delta function.

In step S530, the video decoder 205 calculates the estimated probability density functions by performing a mathematical convolution. The video decoder 205 calculates the estimated probability density function using the equation below:

as \hat{ƒ}_{X(i,j)}(x)=*(U_{i,j,0}*U_{i,j,1}* . . . * . . . *U_{i,j,T})(x) (3)

where the symbol “*” denotes the well-known mathematical concept of convolution, defined by (U*V)(x)=∫_{-∞}^{+∞}U(y)V(x−y)dy.

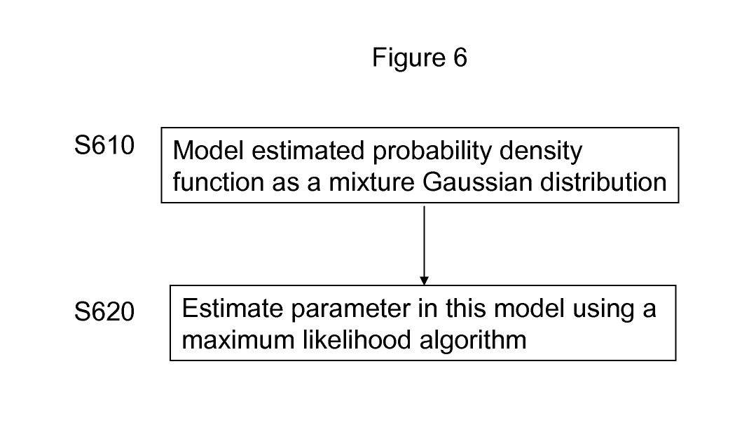

FIG. 6 illustrates a method of estimating probability density functions according to yet another embodiment.

In step S610, the video decoder 205 models the estimated probability density functions as mixture Gaussian distributions, according to the following equation:

$${\hat{f}}_{X ( i , j )} ( x ) = {\sum }_{k = 1}^{K} {ω}_{k} ( i , j ) η ( x ; {μ}_{k} ( i , j ) , {σ}_{k} ( i , j ) ) \qquad ( 4 )$$

where the parameter η(x;μₖ(i,j),σₖ(i,j)) is the Gaussian distribution given by

$$η ( x ; {μ}_{k} ( i , j ) , {σ}_{k} ( i , j ) ) = \frac{1}{\sqrt{2 π} {σ}_{k} ( i , j )} {e}^{\frac{{σ}_{k} ( i , j )}{2} {( x - {μ}_{k} ( i , j ) )}^{2}}$$

where the parameters μₖ(i,j),σₖ(i,j) are the mean and variance of the Gaussian distribution, respectively, and the parameter ωₖ(i,j) is the amplitude of the Gaussian η(x; μₖ(i,j),σₖ (i,j)).

In step S620, the parameters ωₖ(i,j), μₖ(i,j), σₖ(i,j) are computed by a maximum likelihood algorithm using Y=φX. For example a well-known belief propagation algorithm such as “Estimation with Random Linear Mixing, Belief Propagation and Compressed Sensing” by Sundeep Rangan, arViv:1001.2228v2 [cs.IT] 18 May 2010, can be used to estimate the parameters ωₖ(i,j),μₖ(i,j),σₖ(i,j) from the measurements Y.

Referring back to FIG. 3, using the estimated probability density functions, the video decoder 205 identifies a background image and at least one foreground image based upon estimated probability density functions in step S330.

The background image can be constructed by using the mode of the estimated probability density functions. The mode of a distribution ƒ(x) is the value of x where ƒ(x) is maximum. That is, the background image can be defined as:

$${X}_{bg } ( i , j ) = {arg max}_{x} {\hat{f}}_{X ( i , j )} ( x ) \qquad ( 5 )$$

where X_{bg}(i,j) is the pixel value of the background at spatial coordinate (i,j).

FIG. 7 illustrates an example, according to at least one embodiment, of determining the background image based upon the mode of a distribution.

It is noted that there is only one background image in the sequence of frames X(i,j,t), t=0, 1, 2, . . . T , which reflects the assumption that there is a relatively constant environment. It is further noted that, as can be seen from (5), the video decoder 205 only needs to have knowledge of the estimated probability density functions \hat{ƒ}_{X(i,j)}(x). The video decoder 205 does not require knowledge of X(i,j,t) or its approximation \hat{X}(i,j,t).

Example embodiments may perform complete identification of foreground images in order to detect at least one object of interest. According to these embodiments, the video decoder 205 requires knowledge of X(i,j,t) or its approximation \hat{X}(i,j,t), in addition to \hat{ƒ}_{X(i,j)}(x). \acute{X}(i,j,t) may be computed as discussed above regarding Step S510. After X(i,j,t) is computed, the video decoder 205 performs a background subtraction to obtain the foreground as follows:

X_{fg}(i,j,t)=\acute{X}(i,j,t)−X_{bg}(i,j) (6)

where the foreground X_{fg}(i,j,t) represents at least one object of interest.

In Step 340, the video decoder 205 examines the foreground images X_{fg}(i,j,t) to detect objects of interest in the video.

However, it is noted that other example embodiments according to the method of FIG. 3 may be used without identifying the foreground images according to (6). According to these example embodiments, only the shape of an object and how the object moves is of interest. FIG. 8 illustrates a method according to these example embodiments to detect objects of interest based upon a shape property and a motion property of an object.

In these example embodiments, the video decoder 205 determines the shape and motion of an object using only the pdf \hat{ƒ}_{X(i,j)}(x), without having to know X(i,j,t) or its approximation \hat{X}(i,j,t).

In step S810, for each pixel (i,j) at a given time instance t, the video decoder calculates a mean pixel value as follows:

$${X}_{mean} ( i , j , t ) = \frac{1}{2} ( {X}_{max} ( i , j , t ) - {X}_{min} ( i , j , t ) ) \qquad ( 7 )$$

where [Xₘᵢₙ(i,j,t),Xₘₐₓ(i,j,t)] is the range of values of X(i,j,t) satisfying Y=φX as given in Step S510.

In step S820, the video decoder 205 calculates criteria representing the shape of a foreground object as follows:

O(t)={(i,j)∥Xₘₑₐₙ(i,j,t)−X_{bg}(i,j)|>αX_{bg}(i,j) and \hat{ƒ}_{X(i,j)}(Xₘₑₐₙ)<β\hat{ƒ}_{X(i,j)}(X_{bk})} (8)

where the constants α and β are real numbers between 0 and 1 and are tuned to specific values for a specific problem. The constants α and β are used to compute a first threshold value αX_{bg}(i,j) and a second threshold value β\hat{ƒ}_{X(i,j)}(X_{bk}), respectively. In (8), \hat{ƒ}_{X(i,j)}(Xₘₑₐₙ₎ and \hat{ƒ}_{X(i,j)}(X_{bk}) are values of the distribution, defined for example from (4), evaluated at Xₘₑₐₙ and X_{bk}, respectively. For example, \hat{ƒ}_{X(i,j)}(Xₘₑₐₙ) indicates how frequently the pixel X(i,j) takes the value Xₘₑₐₙ, the larger \hat{ƒ}_{X(i,j)}(Xₘₑₐₙ) is, the more frequently X(i,j) is equal to Xₘₑₐₙ. The significance of the first threshold value and the second threshold value are further described below.

Example embodiments should not be limited to performing the computations of (8) in any particular order. Rather, the video decoder 205 will detect an object of interest only when both criteria exceed thresholds, regardless of the order in which the criteria are computed.

Equation (8) can be interpreted according to example embodiments to signify that an object of interest consists of those pixels whose values have a significantly different distribution from the background.

The first comparison of (8) states that the expected value of the pixel value of an object is quite different from the pixel value of the background. The second comparison of (8) states that pixel values of the object appear very infrequently compared to the pixel value of the background. The second comparison is necessary to avoid classifying a moving background, such as waving trees, as a foreground object. If the shape of a foreground object meets both criteria of (8), the video decoder 205 will detect that the foreground object is an object of interest S840.

If at least one object of interest is detected, the video decoder 205 may transmit information indicating that at least one object has been detected. Alternatively, if no object of interest is detected, the process may proceed back to step S810.

The example embodiments described above are directed to video data that contains only luminance, or black-and-white data. Nevertheless, it is noted that example embodiments can be extended to uses in which color data is present in the video data. In this regard, a color video contains pixels that are broken into components. Example components are either R, G, B, or Y, U, V, as is known in the art. When R, G, B data are used, in example embodiments, estimated probability density functions are determined for each component as follows: \hat{ƒ}_{R(i,j)}(x), \hat{ƒ}_{G(i,j)}(x) and \hat{ƒ}_{B(i,j)}(x).

As a result, the embodiments provide reliable detection of objects of interest in video data while using an amount of data that is a small fraction of the total number of pixels of the video. Further, the embodiments enable a surveillance network to have a reduced bandwidth requirement. Further, the embodiments provide relatively low complexity for the camera assemblies, low power consumption for wireless cameras and the same transmitted measurements can be used to reconstruct high quality video of still scenes.

Variations of the example embodiments are not to be regarded as a departure from the spirit and scope of the example embodiments, and all such variations as would be apparent to one skilled in the art are intended to be included within the scope of this disclosure.

What is claimed:

1. A method of detecting at least one object of interest within data in a communication network, comprising:
receiving, by a decoder, a set of measurements, the set of measurements being coded data representing video data;
estimating, by the decoder, probability density functions based upon the set of measurements;
identifying, by the decoder, a background image and at least one foreground image based upon the estimated probability density functions; and
examining the at least one foreground image to detect at least one object of interest.

2. The method of claim 1, wherein the estimating comprises:
obtaining, by the decoder, a range of pixel values of video data that satisfy an expression characterizing a relationship based upon the set of measurements;
determining intermediate functions based upon the range of pixel values; and
performing a convolution of the intermediate functions to obtain the estimated probability density functions.

3. The method of claim 1, wherein the estimating comprises:
obtaining, by the decoder, estimated pixel values of the video data that satisfy a minimization problem; and
determining, by the decoder, histograms based upon the estimated pixel values, the histograms representing the estimated probability distribution functions.

4. The method of claim 1, wherein the estimating models the estimated probability density functions as a mixture Gaussian distribution.

5. The method of claim 1, wherein the identifying identifies the background image using a mathematical mode of the estimated probability density functions.

6. The method of claim 1, wherein the examining comprises:
obtaining, by the decoder, estimated pixel values of the video data that satisfy a minimization problem;
obtaining, by the decoder, at least one foreground image by subtracting the background image from the estimated pixel values of the video data; and
examining the at least one foreground image to detect at least one object of interest.

7. The method of claim 1, wherein the examining comprises:
obtaining, by the decoder, a range of pixel values of video data that satisfy an expression characterizing a relationship based upon the set of measurements;
determining, by the decoder, a shape property and a motion property of the at least one foreground object; and
examining the shape property and the motion property of the at least one foreground object to detect at least one object of interest.

8. The method of claim 1, wherein the video data is luminance data.

9. The method of claim 1, wherein the video data is chrominance data.

10. An apparatus for detecting at least one object of interest within video data, the apparatus comprising:
a decoder configured to receive a set of measurements, the measurements being coded data representing the video data,
the decoder configured to estimate probability density functions for the video data based upon the set of measurements,
the decoder configured to identify a background image and at least one foreground image based upon the estimated probability density functions, and
the decoder configured to examine the at least one foreground image to detect at least one object of interest.

11. The apparatus of claim 10, wherein the decoder is further configured to:
obtain a range of pixel values of video data that satisfy an expression characterizing a relationship based upon the set of measurements;
determine intermediate functions based upon the range of pixel values; and
perform a convolution of the intermediate functions to obtain the estimated probability density functions.

12. The apparatus of claim 10, wherein the decoder is further configured to:
obtain estimated pixel values of the video data that satisfy a minimization problem;
determine histograms based upon the estimated pixel values, the histograms representing the estimated probability distribution functions.

13. The apparatus of claim 10, wherein the decoder is configured to model the estimated probability density functions as a mixture Gaussian distribution.

14. The apparatus of claim 10, wherein the decoder is configured to identify the background image using a mathematical mode of the estimated probability density functions.

15. The apparatus of claim 10, wherein the decoder is further configured to:
obtain estimated pixel values of the video data that satisfy a minimization problem;
obtain at least one foreground image by subtracting the background image from the estimated pixel values of the video data; and
examine the at least one foreground image to detect at least one object of interest.

16. The apparatus of claim 10, wherein the decoder is further configured to:
obtain a range of pixel values of video data that satisfy an expression characterizing a relationship based upon the set of measurements;
determine a shape property and a motion property of the at least one foreground object; and
examine the shape property and the motion property of the at least one foreground object to detect at least one object of interest.

17. The apparatus of claim 10, wherein the video data is luminance data.

18. The apparatus of claim 10, wherein the video data is chrominance data.
